(19) United States
(12) Patent Application Publication
(10) Pub. No.: US 2026/0180788 A1
(43) Pub. Date: Jun. 25, 2026

(54) PROGRAM EXECUTION SYSTEM, PROGRAM EXECUTION METHOD, AND PROGRAM

(71) Applicant: NTT, Inc., Tokyo (JP)

(72) Inventors: Tetsuya OKUDA, Tokyo (JP); Masami IZUMI, Tokyo (JP); Kenji UMAKOSHI, Tokyo (JP); Keiichiro KASHIWAGI, Tokyo (JP); Koki MITANI, Tokyo (JP); Tomohiro INOUE, Tokyo (JP); Daigoro YOKOZEKI, Tokyo (JP); Yoshihito OSHIMA, Tokyo (JP)

(21) Appl. No.: 19/132,456

(22) PCT Filed: Dec. 8, 2022
(86) PCT No.: PCT/JP2022/045341

§ 371 Date: May 23, 2025

(51) Int. Cl. H04L 9/08; H04L 9/30; H04L 9/32

(52) U.S. Cl. CPC H04L 9/0825; H04L 9/30; H04L 9/3236; H04L 9/3247

(57) ABSTRACT

A program execution system includes a data holding apparatus configured to transmit a second ciphertext obtained by encrypting a common key with a public key, to a data processing apparatus, and includes the data processing apparatus configured to acquire the common key that is obtained by decrypting the second ciphertext with a secret key, and acquire data by decrypting a first ciphertext with the common key in an isolated region. In the isolated region, the data processing apparatus is configured to calculate a result of processing the data by a program that is held in the isolated region.

### TECHNICAL FIELD

The present invention relates to a confidential execution technology in an information and communication field.

### BACKGROUND ART

As conventional technologies that perform calculations while keeping data and programs confidential from cloud business operators, for example, there are confidential computing (Non-Patent Literature 1), confidential VM (Non-Patent Literature 2) and the like. By these technologies, for example, it is possible to isolate and keep highly confidential data secret while the data is processed in a cloud.

However, in these technologies, there is a problem that users cannot know when platform business operators that provide the above-described cloud environment actively tamper with public keys, policies, or the like.

### CITATION LIST

### Non-Patent Literature

Non-Patent Literature 1: Microsoft Azure Confidential Computing official web page https://docs.microsoft.com/ja-jp/azure/confidential-computing/overview
Non-Patent Literature 2: Google Confidential VM official web page https://cloud.google.com/compute/confidential-vm/docs?hl=ja

### SUMMARY OF INVENTION

### Technical Problem

The present invention has been made in view of the above point, and an object of the present invention is to provide a technology that, when processing data of a data holder by a program of a program provider using a data processing apparatus with a confidential calculation mechanism, prevents the program from leaking to a person other than the program provider, prevents the data from leaking to a person other than the data holder, and can detect tampering of a public key or a policy by a person who manages the data processing apparatus.

### Solution to Problem

According to the disclosed technology, a program execution system is provided, the program execution system including a data holding apparatus and a data processing apparatus including a mechanism that performs confidential calculation in an isolated region,
the data holding apparatus transmitting a ciphertext Enc(D, Kd2) obtained by encrypting data D with a common key Kd2 to the data processing apparatus,
the data processing apparatus transmitting a public key PKs0 corresponding to a secret key SKs0 held in the isolated region and H(PKs0) (where H is a hash function) to which a signature is added by a hardware secret key included in hardware that implements the isolated region to the data holding apparatus,
the data holding apparatus transmitting a ciphertext PubEnc(Kd2, PKs0) obtained by encrypting the common key Kd2 with the public key PKs0 to the data processing apparatus,
the data processing apparatus acquiring the common key Kd2 by decrypting the ciphertext PubEnc(Kd2, PKs0) with the secret key SKs0 and acquiring the data D by decrypting the ciphertext Enc(D, Kd2) with the common key Kd2 in the isolated region, and
the data processing apparatus calculating a result P(D) of processing the data D by a program P held in the isolated region, in the isolated region.

### Effects of Invention

According to the disclosed technology, in a case where data of a data holder is processed by a program of a program provider by a data processing apparatus including a confidential calculation mechanism, it is possible to prevent the program from being leaked to a person other than the program provider, prevent the data from being leaked to a person other than the data holder, and detect falsification of a public key or a policy by a person who manages the data processing apparatus.

### BRIEF DESCRIPTION OF DRAWINGS

FIG. 1 is a diagram illustrating a system configuration example according to an embodiment of the present invention.

FIG. 2 is a diagram illustrating a functional configuration example of a data processing apparatus.

FIG. 3 is a diagram illustrating an image of processing in a secure region.

FIG. 4 is a sequence diagram (1/4) indicating flow of processing according to the embodiment.

FIG. 5 is a sequence diagram (2/4) indicating the flow of the processing in the embodiment.

FIG. 6 is a sequence diagram (3/4) indicating the flow of the processing according to the embodiment.

FIG. 7 is a sequence diagram (4/4) indicating the flow of the processing according to the embodiment.

FIG. 8 is a diagram illustrating a hardware configuration example of an apparatus.

### DESCRIPTION OF EMBODIMENTS

Hereinafter, one or more embodiments of the present invention (the present embodiment) will be described with reference to the drawings. Each embodiment to be described below is merely one example, and embodiments to which the present invention is applied are not limited to the following embodiments. In the following description, a program is denoted as P, data to be processed by P is denoted as D, and a processing result (execution result) of D by P is denoted as P(D).

### (Example of System Configuration)

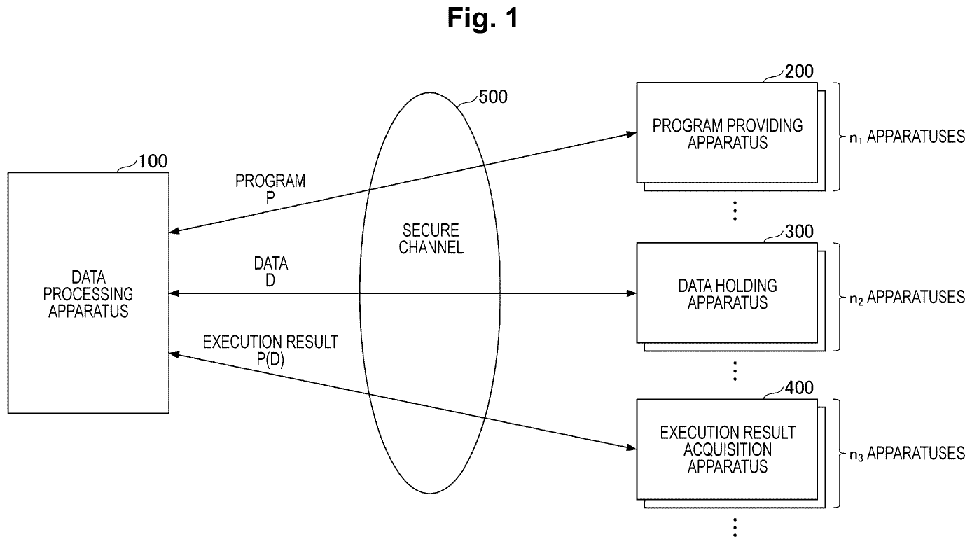

FIG. 1 illustrates a configuration example of a program execution system according to the embodiment of the present invention. As illustrated in FIG. 1, the program execution system according to the present embodiment includes a data processing apparatus 100, n₁ program providing apparatuses 200, n₂ data holding apparatuses 300, and n₃ execution result acquisition apparatuses 400. Here, n₁ is an integer equal to or greater than 0, n₂ is an integer equal to or greater than 1, and n₃ is an integer equal to or greater than 0. Note that in a case where n₁=0, the program providing apparatus 200 is configured integrally with the data processing apparatus 100. Further in a case where n₃=0, the program execution system does not include an execution result acquisition apparatus 400. In the following, as an example, it is assumed that n₁=n₂=n₃=1.

Each of the data processing apparatus 100, the program providing apparatus 200, the data holding apparatus 300, and the execution result acquisition apparatus 400 may be a physical machine (computer) or a virtual machine. In addition, each of the program providing apparatus 200, the data holding apparatus 300, and the execution result acquisition apparatus 400 may be a function (for example, a web browser) that operates on the physical machine or the virtual machine. Further, the data processing apparatus 100 may be a system comprised of a plurality of physical machines.

In the present embodiment, the data processing apparatus 100 includes a secret calculation mechanism or a confidential calculation mechanism, by the application of a function that executes data processing in isolation from an existing OS, which is called a trusted execution environment (TEE) function. In the present embodiment, for example, SEV of AMD (registered trademark) is assumed as the TEE function. However, this is merely an example, and the present invention can be applied to any TEE function. For example, the present invention can also be applied to SGX or TDX from Intel (registered trademark), TrustZone (registered trademark), ARM Confidential Compute Architecture of Arm (registered trademark), or the like.

As illustrated in FIG. 1, a secure channel 500 is constructed between the data processing apparatus 100 and the program providing apparatus 200, between the data processing apparatus 100 and the data holding apparatus 300, and between the data processing apparatus 100 and the execution result acquisition apparatus 400, and as a result, data and programs can be safely transmitted and received. The secure channel 500 is constructed, for example, using https, TLS, or the like, or after executing a remote authentication protocol called remote attestation in the TEE. However, this is merely an example, and the secure channel 500 may be constructed with any approach. Furthermore, the construction of the secure channel 500 is not essential.

In the present embodiment, the program P is transmitted from the program providing apparatus 200 to the data processing apparatus 100, the data D is transmitted from the data holding apparatus 300 to the data processing apparatus 100. The data processing apparatus 100 processes the data D by the program P, and provides an execution result P(D) to the execution result acquisition apparatus 400. However, for example, the data processing apparatus 100 may acquire the program P from the program providing apparatus 200. Similarly, the data processing apparatus 100 may acquire the data D from the data holding apparatus 300. Also, the execution result acquisition apparatus 400 may acquire the execution result P(D) from the data processing apparatus 100.

With the secret calculation mechanism, the data processing apparatus 100 does not leak the program P and the data D outside a secure region (for example, to a cloud on which the data processing apparatus 100 is operating). In addition to this configuration, the present embodiment implements a mechanism in which the program P does not leak to the data holding apparatus 300 and the execution result acquisition apparatus 400, the data D does not leak to the program providing apparatus 200 and the execution result acquisition apparatus 400, and the execution result P (D) does not leak to the program providing apparatus 200 and the data holding apparatus 300. Further, in addition to this, the present embodiment also implements a mechanism that enables a program provider, a data holder, and an execution result acquirer to detect both tampering of a public key for implementing the mechanism and tampering of a policy for access control and the like. Here, the program provider is a provider of the program P, and is, for example, a user, an administrator, or the like, of the program providing apparatus 200. The data holder is a holder of the data D, and is, for example, a user, an administrator, or the like, of the data holding apparatus 300. The execution result acquirer is an acquirer of the execution result P (D), and is, for example, a user, an administrator, or the like, of the execution result acquisition apparatus 400. On the other hand, an administrator, an owner, and the like, of the data processing apparatus 100 are referred to as a platform business operator (abbreviated as a “PF business operator”). In addition, the program provider, the data holder, and the execution result acquirer will be collectively referred to as “users”. Note that, for example, the execution result acquirer may be identical to to either the program provider or the data holder.

In this arrangement, in the program execution system according to the present embodiment, in a use case where the secret calculation mechanism is applied to data distribution, it is possible to combine and execute the highly confidential data D held by the data holder and the highly confidential program P held by the program provider, while keeping the data D and the program P confidential, and thereby provide an execution result to an execution result acquirer. Furthermore, in addition to this, each user (the program provider, the data holder, the execution result acquirer) can verify that the public key or the policy are not tampered with by the PF business operator. As a result, when tampering the public key and the policy, each user can detect the tampering.

### (Functional Configuration Example of Data Processing Apparatus 100)

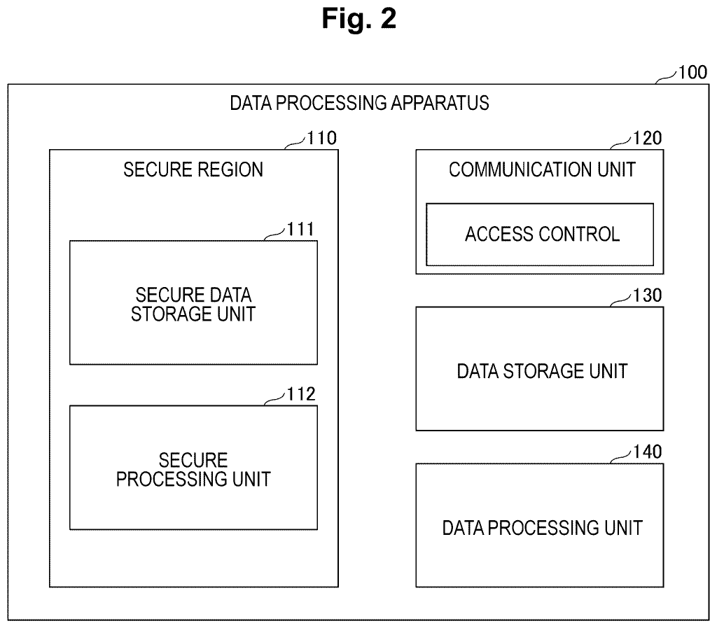

FIG. 2 illustrates a functional configuration example of the data processing apparatus 100. As illustrated in FIG. 2, the data processing apparatus 100 includes a secure region 110 that is a protected region (may be referred to as an isolated region) in which confidentiality is maintained, and includes a communication unit 120 that performs data communication with other devices (for example, the program providing apparatus 200, the data holding apparatus 300, and the execution result acquisition apparatus 400), a data storage unit 130 that stores data in a storage or the like outside the secure region 110, and a data processing unit 140 that performs various data processing outside the secure region 110.

Data and programs in the secure region 110 cannot be known from the outside. Outside the secure region 110, the data storage unit 130 and the data processing unit 140 can respectively perform normal data storage and data processing (program execution). It is also possible to perform data communication, and access control when performing the data communication, by the communication unit 120.

In the secure region 110, data storage and data processing (program execution) can be performed while maintaining the confidentiality. FIG. 2 illustrates a secure data storage unit 111 and a secure processing unit 112 as functional units that perform the above storage and processing in the secure region 110. The secure data storage unit 111 stores various data in a storage region while maintaining the confidentiality in the secure region 110. In addition, the secure processing unit 112 performs data processing (such as activation and execution of the program P, generation (calculation) of a secret key and a public key, encryption, decryption, signature verification, access control by a role) in the secure region 110. Note that the role is a term used in role-based access control, and refers to, for example, information such as an authority label. Examples of the role include a team administrator, a channel administrator, a channel participant, and the like.

The secure region 110 itself can be implemented by an existing technology. Any technology may be used as the existing technology for implementing the secure region 110. For example, the secure region 110 may be implemented as a separate chip independent of a main CPU and/or a main memory in terms of hardware, or the secure region 110 may be implemented in terms of software by utilizing an encryption technology and an authentication technology. As a technology that implements the secure region 110 in terms of software, for example, the SEV described above exists, and it is assumed that the SEV is used as an example in the present embodiment. In this case, the secure region 110 is generated as an encrypted virtual machine (VM) (or may be a container created on the virtual machine) in the data processing apparatus 100. Such an encrypted VM (or an encrypted container) is also referred to as a sandbox or a data sandbox (DSB). For example, when a plurality of encrypted VMs are generated, a plurality of secure regions 110 exist.

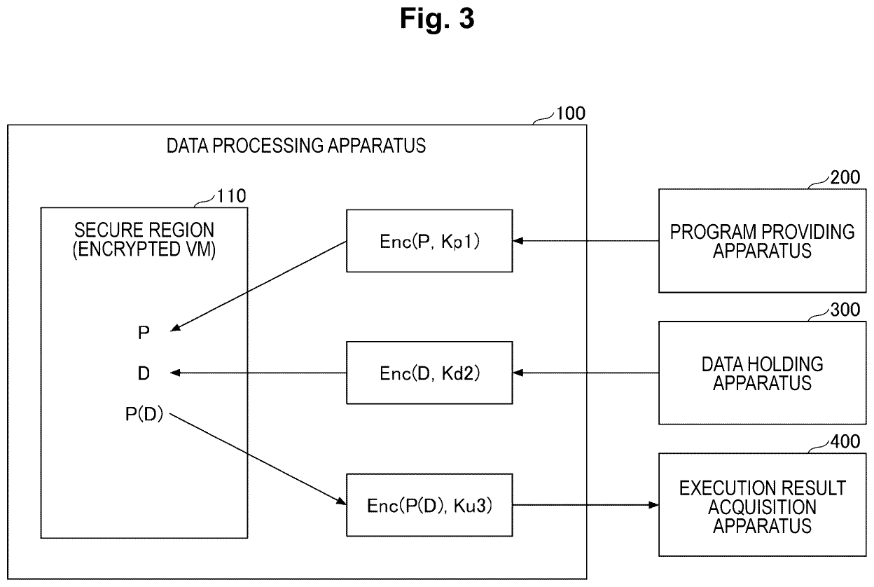

FIG. 3 illustrates an image of data processing in the secure region 110. Here, in the present embodiment, “Enc” refers to encryption by a common key (or a shared key)-based encryption scheme, and Enc(A, B) represents data obtained by encrypting A with B (common key) using the common key-based encryption scheme. Furthermore, “PubEnc” refers to encryption by a public key-based encryption scheme, and PubEnc(A, B) represents data obtained by the encrypting A with B (public key) using the public key-based encryption scheme. Further, in the following description, it is assumed that Kp1 is a common key of the program provider, Kd2 is a common key of the data holder, and Ku3 is a common key of the execution result acquirer.

As illustrated in FIG. 3, the data processing apparatus 100 receives Enc(P, Kp1) from the program providing apparatus 200, and receives Enc(D, Kd2) from the data holding apparatus 300.

In the secure region 110, Enc(P, Kp1) and Enc(D, Kd2) are decrypted, and thus the program P and the data D are obtained. Thereafter, in the secure region 110, the execution result P (D) is calculated, and Enc(P(D), Ku3) is calculated. Then, Enc(P(D), Ku3) is transmitted to the execution result acquisition apparatus 400.

In this arrangement, in addition to the fact that the program P and the data D do not leak to the PF operator, it is possible to provide the execution result P(D) only to the execution result acquirer, while the program P does not leak to a person other than the program provider and the data D does not leak to a person other than the data holder. In the following, such a process is also referred to as “confidential program execution”.

Furthermore, in this case, in the embodiment described later, each user can verify that the public key of the secure region 110 (encrypted VM) and the policy of the encrypted VM are not tampered with. As a result, while confidential program execution is performed, each user can detect, for example, falsification of the public key or the policy by the PF operator.

### Example

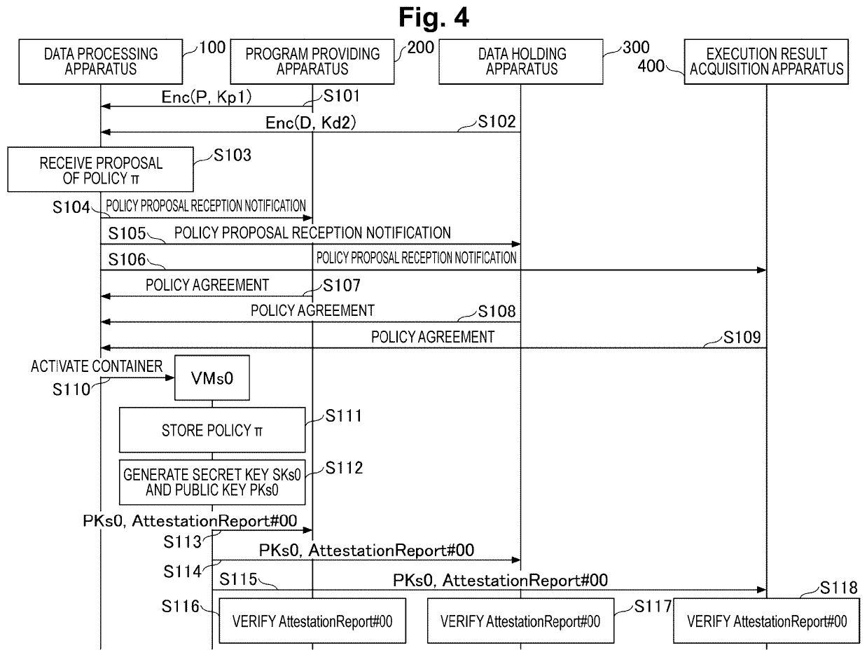

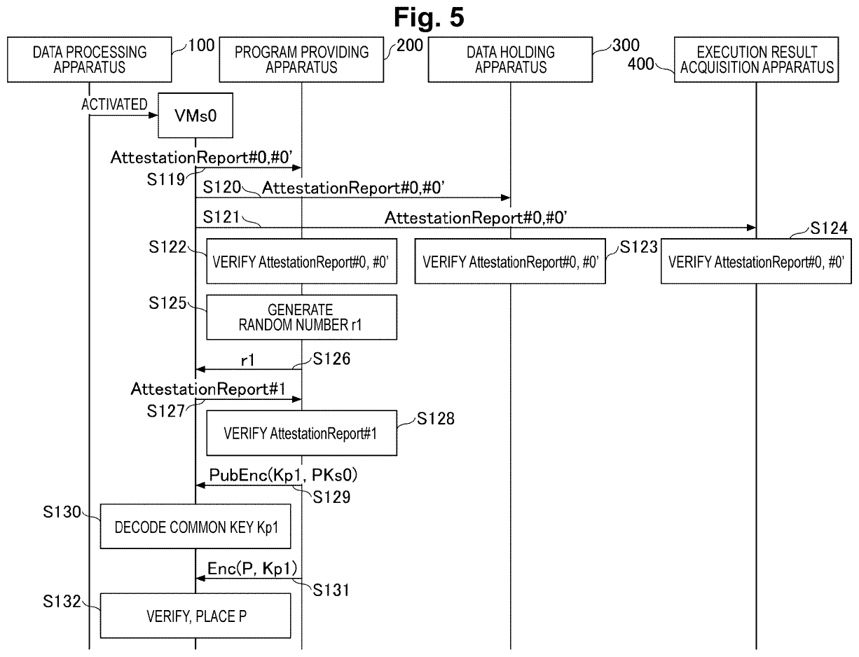

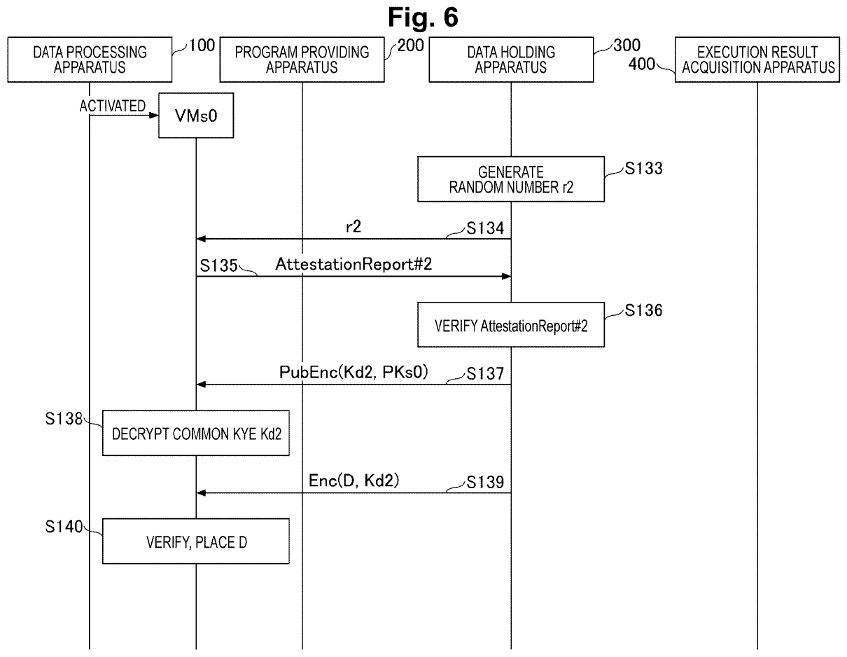

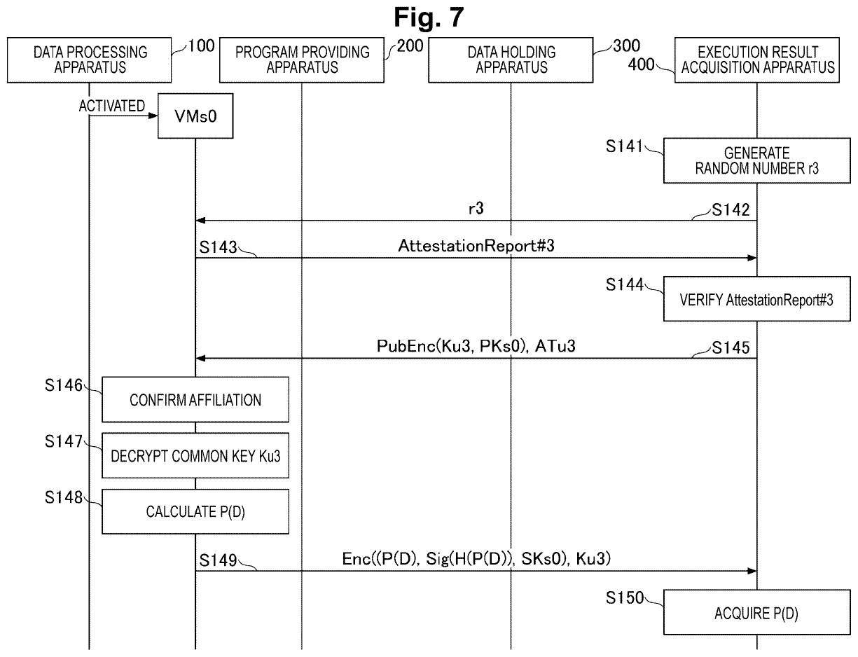

Hereinafter, an example of a processing flow in the present embodiment will be described with reference to FIGS. 4 to 7. However, in the following description, H (A) represents a hash value of A using a hash function H, and Sig (A, B) represents a signature of A by B (secret key). In addition, it is assumed that the user has generated both a public key and a secret key corresponding to the public key in advance, and that the public key has been distributed in advance to a person who needs the public key. Furthermore, it is assumed that, after activating the container, there is no replacement of programs operating on the container. As a result, for example, it is ensured that there is no fraud such as returning of an execution result of a program B while presenting an execution evidence of a program A.

In S101, the program providing apparatus 200 transmits Enc(P, Kp1) to the data processing apparatus 100. The Enc(P, Kp1) is stored in a public storage region such as a storage of the data processing apparatus 100, by the data storage unit 130.

In S102, the data holding apparatus 300 transmits Enc(D, Kd2) to the data processing apparatus 100. The Enc(D, Kd2) is stored in a public storage region such as a storage of the data processing apparatus 100, by the data storage unit 130.

In S103, the data processing apparatus 100 receives a proposal of a policy m from a policy proposer. Here, the policy proposer is not limited to a specific person and may be any person. For example, the policy proposer may be a person other than the PF business operator and the user (the program provider, the data holder, the execution result acquirer), may be the PF business operator, or may be any user. Note that, in the following description, as an example, it is assumed that the policy π is proposed, but for example, there may be a case where the policy π is accepted in advance by any approach and then the policy π is not checked. Thus, the policy π does not have to be proposed and received in this step, and the policy π does not need to be used.

The policy π is information to be used for access control and the like, and, for example, a public key of a user belonging to a certain role, the certain role, and a permission assigned to the user, are specified. In the present embodiment, it is assumed that the policy π to enable at least execution of P(D) or acquisition of the execution result P(D) by the execution result acquirer is proposed. Here, the policy π includes at least H(P). Note that, in a case where the data D is determined when the policy π is accepted, the policy π may further include H(D). In the following, as an example, it is assumed that the data D is confirmed when the policy π is accepted, and the policy π includes H(P) and H(D).

In S104, the data processing apparatus 100 transmits a policy proposal reception notification for acknowledging the receipt of the proposal of the policy π, to the program providing apparatus 200.

In S105, the data processing apparatus 100 transmits the policy proposal reception notification for acknowledging the receipt of the proposal of the policy π, to the data holding apparatus 300.

In S106, the data processing apparatus 100 transmits the policy proposal reception notification for acknowledging the receipt of the proposal of the policy π, to the execution result acquisition apparatus 400.

The program providing apparatus 200 that has received the policy proposal reception notification displays a screen including a display component such as a button for selecting whether to agree or disagree with the policy π, to the program provider. Similarly, the data holding apparatus 300 that has received the policy proposal reception notification displays a screen including a display component such as a button for selecting whether to agree or disagree with the policy π, to the data holder. Similarly, the execution result acquisition apparatus 400 that has received the policy proposal reception notification displays a screen including a display component such as a button for selecting whether to agree or disagree with the policy π, to the execution result acquirer. In the following, it is assumed that the program provider, the data holder, and the execution result acquirer perform operations to agree with the policy m.

In S107, the program providing apparatus 200 transmits a policy agreement indicating agreement with the policy, to the data processing apparatus 100.

In S108, the data holding apparatus 300 transmits a policy agreement indicating agreement with the policy π, to the data processing apparatus 100.

In S109, the execution result acquisition apparatus 400 transmits a policy agreement indicating agreement with the policy π, to the data processing apparatus 100.

In S110, when receiving the policy agreements from the program providing apparatus 200, the data holding apparatus 300, and the execution result acquisition apparatus 400, the data processing apparatus 100 generates and activates a container, and then encrypts the container. As a result, the encrypted VM that functions as the secure region 110 is generated. In the following, the encrypted VM generated in this case is referred to as “VMs0”. It is assumed that an owner of the VMs0 is a person other than the users (the program provider, the data holder, and the execution result acquirer). For example, an administrator of the confidential program execution, the policy proposer, or the like may be the owner of the VMs0.

In S111, the VMs0 of the data processing apparatus 100 stores the policy π in the container.

In S112, the VMs0 of the data processing apparatus 100 generates both a secret key SKs0 and a public key PKs0 corresponding to the secret key SKs0. The secret key SKs0 and the public key PKs0 are stored in the container.

In S113, the VMs0 of the data processing apparatus 100 issues AttestationReport #00 and transmits PKs0 and AttestationReport #00 to the program providing apparatus 200. Here, AttestationReport #00 is information for verifying that the public key PKs0 is not tampered with and includes, for example, H(PKs0) and Sig(H(PKs0), VCEK_SK). The VCEK_SK is a secret key (that is, a secret key of hardware (TEE firmware)) called an endorsement key (EK) stored in the TEE firmware, and in the present embodiment, assumes a secret key of a versioned chip endorsement key (VCEK). However, the EK is not limited to the VCEK, and the present embodiment can be similarly applied to other EKs.

In S114, the VMs0 of the data processing apparatus 100 transmits PKs0 and AttestationReport #00 to the data holding apparatus 300.

In S115, the VMs0 of the data processing apparatus 100 transmits PKs0 and AttestationReport #00 to the execution result acquisition apparatus 400.

In S116, the program providing apparatus 200 verifies AttestationReport #00. In other words, the program providing apparatus 200 verifies the signature Sig(H(PKs0), VCEK_SK) using VCEK PK acquired in advance, then calculates a hash value of the public key PKs0 using the hash function H, and verifies whether the hash value matches H(PKs0) included in AttestationReport #00. This allows the program provider to verify whether the public key PKs0 is tampered with. Note that if the hash value matches H(PKs0), it means that the public key PKs0 is not tampered with; and if the hash value does not match H(PKs0), it means that the public key PKs0 is tampered with. Here, VCEK PK is a public key corresponding to VCEK_SK. In the following, it is assumed that it has been verified that the public key PKs0 is not tampered with.

In S117, the data holding apparatus 300 verifies AttestationReport #00. In other words, the data holding apparatus 300 verifies the signature Sig(H(PKs0), VCEK_SK) using VCEK PK acquired in advance, then calculates a hash value of the public key PKs0 using the hash function H, and verifies whether the hash value matches H(PKs0) included in AttestationReport #00. This allows the data holder to verify whether the public key PKs0 is tampered with. In th following, it is assumed that it has been verified that the public key PKs0 is not tampered with.

In S118, the execution result acquisition apparatus 400 verifies AttestationReport #00. In other words, the execution result acquisition apparatus 400 verifies the signature Sig(H(PKs0), VCEK_SK) using VCEK PK acquired in advance, then calculates a hash value of the public key PKs0 using the hash function H, and verifies whether the hash value matches H(PKs0) included in AttestationReport #00. This allows the execution result acquirer to verify whether the public key PKs0 is tampered with. In the following, it is assumed that it has been verified that the public key PKs0 is not tampered with.

In S119, the VMs0 of the data processing apparatus 100 issues either or both of AttestationReport #0 and AttestationReport #0′, and transmits the issued result to the program providing apparatus 200. Here, AttestationReport #0 is information for verifying that the agreed policy π is not tampered with, and includes, for example, H(H(PKs0), H(π)) and Sig(H(H(PKs0), H(π)), VCEK_SK). Similarly, AttestationReport #0′ is information for verifying that the approved policy π is not tampered with, and includes, for example, H(π) and Sig(H(π), SKs0). In the following, a case where both AttestationReport #0 and AttestationReport #0′ are issued will be described as an example, but only one of AttestationReport #0 and AttestationReport #0′ may be issued as described above.

Note that each user can create H(H(PKs0), H(π)) and H(π) by themselves.

In S120, the VMs0 of the data processing apparatus 100 transmits AttestationReport #0 and AttestationReport #0′ to the data holding apparatus 300.

In S121, the VMs0 of the data processing apparatus 100 transmits AttestationReport #0 and AttestationReport #0′ to the execution result acquisition apparatus 400.

In S122, the program providing apparatus 200 verifies AttestationReport #0 and AttestationReport #0′. In other words, the program providing apparatus 200 verifies the signature Sig(H(H(PKs0), H(π)), VCEK_SK) using VCEK PK acquired in advance, and then, calculates a hash value of a character string obtained by combining the hash value of the policy π agreed by the program providing apparatus 200 and the hash value of the public key PKs0 using the hash function H and verifies whether or not the hash value matches H(H(PKs0), H(π)) included in AttestationReport #0. Similarly, the program providing apparatus 200 verifies Sig(H(π), SKs0) by using the public key PKs0, then calculates a hash value of the policy π agreed by the program providing apparatus 200 using the hash function H and verifies whether or not the hash value matches H(π) included in AttestationReport #0′. This results in making it possible for the program provider to verify whether or not the policy π is tampered with. Note that a case where the hash values match H(H(PKs0), H(π)) and H(π) means that the policy π is not tampered with, and a case where the hash values do not match H(H(PKs0), H(π)) and H(π) means that the policy π is tampered with. Hereinafter, it is assumed that it has been verified that the policy π is not tampered with.

In S123, the data holding apparatus 300 verifies AttestationReport #0 and AttestationReport #0′. In other words, after verifying the signature Sig(H(H(PKs0), H(π)), VCEK_SK) using VCEK PK acquired in advance, the data holding apparatus 300 calculates a hash value of a character string obtained by combining the hash value of the policy m and the hash value of the public key PKs0 agreed by the data holding apparatus 300 using the hash function H and verifies whether or not the hash value matches H(H(PKs0), H(π)) included in AttestationReport #0. Similarly, after verifying Sig(H(π), SKs0) using the public key PKs0, the data holding apparatus 300 calculates a hash value of the policy π agreed by the data holding apparatus 300 using the hash function H and verifies whether or not the hash value matches H(π) included in AttestationReport #0′. This makes it possible for the data holder to verify whether or not the policy π is tampered with. Hereinafter, it is assumed that it has been verified that the policy π is not tampered with.

In S124, the execution result acquisition apparatus 400 verifies AttestationReport #0 and AttestationReport #0′. In other words, after verifying the signature Sig(H(H(PKs0), H(π)), VCEK_SK) using VCEK PK acquired in advance, the execution result acquisition apparatus 400 calculates a hash value of a character string obtained by combining the hash value of the policy π agreed by the execution result acquisition apparatus 400 and the hash value of the public key PKs0 using the hash function H and verifies whether or not the hash value matches H(H(PKs0), H (π)) included in AttestationReport #0. Similarly, after verifying Sig(H(π), SKs0) using the public key PKs0, the execution result acquisition apparatus 400 calculates a hash value of the policy π agreed by the execution result acquisition apparatus 400 using the hash function H and verifies whether or not the hash value matches H(π) included in AttestationReport #0′. This results in making it possible for the execution result acquirer to verify whether or not the policy π is tampered with. Hereinafter, it is assumed that it has been verified that the policy π is not tampered with.

In S125, the program providing apparatus 200 randomly generates a random number r1.

In S126, the program providing apparatus 200 transmits the random number r1 to the VMs0 of the data processing apparatus 100.

In S127, the VMs0 of the data processing apparatus 100 issues AttestationReport #1 and transmits AttestationReport #1 to the program providing apparatus 200. Here, AttestationReport #1 is information for verifying that VMs0 is in an initial state (that is, a state where the program P and the data D are not stored) and includes, for example, r1 and Sig(r1, SKs0), and H(x1, H(container state)) and Sig(H(x1, H(container state)), VCEK_SK). x1 is either r1 or Sig(r1, SKs0). The container state is a current state (that is, whether it is empty or whether the program P or the data D is stored) of a storage destination directory of the program P and a storage destination directory of the data D. The H(container state) may be, for example, a hash value of a character string obtained by combining a full path of the storage destination directory of the program P, a hash value of a file stored in the storage destination directory of the program P, a full path of the storage destination directory of the data D, and a hash value of a file stored in the storage destination directory of the data D.

In S128, the program providing apparatus 200 verifies AttestationReport #1. In other words, the program providing apparatus 200 verifies whether or not the random number r1 included in AttestationReport #1 is correct (that is, whether or not the random number r1 matches the random number r1 generated by the program providing apparatus 200) after verifying the signature Sig(r1, SKs0) using the public key PKs0. Then, in a case where it has been verified that the random number r1 is correct, the program providing apparatus 200 verifies the signature Sig(H(x1, H(container state)), VCEK_SK) using VCEK PK acquired in advance, calculates a hash value of a character string obtained by combining the hash value of the initial state of the container and x1 using the hash function H and verifies whether or not the hash value matches H(x1, H(container state)) included in AttestationReport #1. Here, the hash value of the initial state of the container is a hash value of information indicating a state before the program P and the data D are stored in the container and may be, for example, a hash value of a character string obtained by combining the full path of the storage destination directory of the program P and the full path of the storage destination directory of the data D. As a result, the program provider can verify whether or not the storage destination directory of the program P and the storage destination directory of the data D are empty (that is, verify whether or not invalid data, or the like, is stored). In a case where the hash value matches H(x1, H(container state)), it means that both the storage destination directory of the program P and the storage destination directory of the data D are empty, and in a case where the hash value does not match H(x1, H(container state)), it means that one of the storage destination directories is not empty. Hereinafter, it is assumed that it has been verified that both the storage destination directory of the program P and the storage destination directory of the data D are empty.

In S129, the program providing apparatus 200 transmits PubEnc(Kp1, PKs0) to the VMs0 of the data processing apparatus 100.

In S130, the VMs0 of the data processing apparatus 100 decrypts PubEnc(Kp1, PKs0) using the secret key SKs0 to acquire a common key Kp1 of the program provider. The common key Kp1 is stored in the container.

In S131, the program providing apparatus 200 transmits Enc(P, Kp1) to the VMs0 of the data processing apparatus 100. However, the present invention is not limited thereto, and for example, Enc(P, Kp1) may be stored in advance in a storage on the data processing apparatus 100 and may be moved from the storage to the VMs0.

In S132, the VMs0 of the data processing apparatus 100 decrypts Enc(P, Kp1) using the common key Kp1, acquires the program P, and then verifies whether or not the hash value of the program P matches H(P) included in the policy π using the hash function H. Then, in a case where it has been verified that the hash value of the program P matches H(P), the VMs0 of the data processing apparatus 100 places the program P in the storage destination directory of the program P.

In S133, the data holding apparatus 300 randomly generates a random number r2.

In S134, the data holding apparatus 300 transmits the random number r2 to the VMs0 of the data processing apparatus 100.

In S135, the VMs0 of the data processing apparatus 100 issues AttestationReport #2 and transmits AttestationReport #2 to the data holding apparatus 300. Here, AttestationReport #2 is information for verifying that only the program P is stored in the VMs0 and includes, for example, r2 and Sig(r2, SKs0), and H(x2, H(container state)) and Sig(H(x2, H(container state)), VCEK_SK). x2 is either r2 or Sig(r2, SKs0).

In S136, the data holding apparatus 300 verifies AttestationReport #2. In other words, the data holding apparatus 300 verifies the signature Sig(r2, SKs0) using the public key PKs0, and then verifies whether or not the random number r2 included in AttestationReport #2 is correct (that is, whether or not the random number r2 matches the random number r2 generated by the data holding apparatus 300). Then, in a case where it has been verified that the random number r2 is correct, the data holding apparatus 300 verifies the signature Sig(H(x2, H(container state)), VCEK_SK) using VCEK PK acquired in advance, and then, calculates a hash value of a character string obtained by combining x2 with a hash value of a character string obtained by combining the initial state of the container and the hash value of the program P using the hash function H and verifies whether or not the hash value matches H(x2, H(container state). As a result, the data provider can verify whether or not “only the program P is stored in the storage destination directory of the program P, and the storage destination directory of the data D is empty”. In a case where the hash value matches H(x2, H(container state), it means that only the program P is stored in the storage destination directory of the program P and the storage destination directory of the data D is empty, and in a case where the hash value does not match H(x2, H(container state), it means that the state is not a state where “only the program P is stored in the storage destination directory of the program P, and the storage destination directory of the data D is empty”. Hereinafter, it is assumed that it has been verified that only the program P is stored in the storage destination directory of the program P and the storage destination directory of the data D is empty.

In S137, the data holding apparatus 300 transmits PubEnc(Kd2, PKs0) to the VMs0 of the data processing apparatus 100.

In S138, the VMs0 of the data processing apparatus 100 decrypts PubEnc(Kd2, PKs0) using the secret key SKs0 to acquire a common key Kd2 of the data holder. The common key Kd2 is stored in the container.

In S139, the data holding apparatus 300 transmits Enc(D, Kd2) to the VMs0 of the data processing apparatus 100. However, the present invention is not limited thereto, and for example, Enc(D, Kd2) may be stored in advance in a storage on the data processing apparatus 100 and may be moved from the storage to the VMs0.

In S140, the VMs0 of the data processing apparatus 100 decrypts Enc(D, Kd2) using the common key Kd2, acquires the data D, and then verifies whether or not the hash value of the data D matches H(D) included in the policy π using the hash function H. Then, in a case where it has been verified that the hash value of the data D matches H(D), the VMs0 of the data processing apparatus 100 places the data D in the storage destination directory of the data D.

In S141, the execution result acquisition apparatus 400 randomly generates a random number r3.

In S142, the execution result acquisition apparatus 400 transmits the random number r3 to the VMs0 of the data processing apparatus 100.

In S143, the VMs0 of the data processing apparatus 100 issues AttestationReport #3 and transmits AttestationReport #3 to the execution result acquisition apparatus 400. Here, AttestationReport #3 is information for verifying that both the program P and the data D are stored in the VMs0 and includes, for example, r3 and Sig(r3, SKs0), and H(x3, H(container state)) and Sig(H(x3, H(container state)), VCEK_SK). x3 is either r3 or Sig(r3, SKs0).

In S144, the execution result acquisition apparatus 400 verifies AttestationReport #3. In other words, the execution result acquisition apparatus 400 verifies the signature Sig(r3, SKs0) using the public key PKs0, and then verifies whether or not the random number r3 included in AttestationReport #3 is correct (that is, whether or not the random number r3 matches the random number r3 generated by the execution result acquisition apparatus 400). Then, in a case where it has been verified that the random number r3 is correct, the execution result acquisition apparatus 400 verifies the signature Sig(H(x3, H(container state)), VCEK_SK) using VCEK PK acquired in advance, calculates a hash value of a character string obtained by combining x3 with a hash value of a character string obtained by combining the initial state of the container, the hash value of the program P, and the hash value of the data D using the hash function H and verifies whether or not the hash value matches H(x3, H(container state). As a result, the execution result acquirer can verify whether or not “only the program P is stored in the storage destination directory of the program P, and only the data D is stored in the storage destination directory of the data D”. Note that in a case where the hash value matches H(x3, H(container state), it means that only the program P is stored in the storage destination directory of the program P, and only the data D is stored in the storage destination directory of the data D, and in a case where the hash value does not match H(x3, H(container state), it means that the state is not a state where “only the program P is stored in the storage destination directory of the program P, and only the data D is stored in the storage destination directory of the data D”. Hereinafter, it is assumed that it has been verified that only the program P is stored in the storage destination directory of the program P and only the data D is stored in the storage destination directory of the data D.

In S145, the execution result acquisition apparatus 400 transmits PubEnc(Ku3, PKs0) and ATu3 to the VMs0 of the data processing apparatus 100. Here, ATu3 is an access token signed with a signature key of the execution result acquirer.

In S146, the VMs0 of the data processing apparatus 100 confirms a role to which the execution result acquirer belongs. In other words, after verifying the signature of the access token by using the public key of the execution result acquirer, the VMs0 of the data processing apparatus 100 confirms the role to which the execution result acquirer belongs by using the public key. Hereinafter, it is assumed that it has been confirmed that the execution result acquirer belongs to a role capable of acquiring the execution result P(D).

In S147, the VMs0 of the data processing apparatus 100 decrypts PubEnc(Ku3, PKs0) using the secret key SKs0 and acquires a common key Ku3 of the execution result acquirer. The common key Ku3 is stored in the container.

In S148, the VMs0 of the data processing apparatus 100 activates the program P and calculates P(D).

In S149, the VMs0 of the data processing apparatus 100 transmits Enc(P(D), Sig(H(P(D)), SKs0), Ku3) to the execution result acquisition apparatus 400.

However, for example, in consideration of a case where there is a delay in a request from the execution result acquisition apparatus 400 after calculation of P(D) in S148 described above, Enc(P(D), Sig(H(P(D)), SKs0), Ku3) may be temporarily stored from the VMs0 in the storage of the data processing apparatus 100 and then transmitted from the storage to the execution result acquisition apparatus 400.

In S150, the execution result acquisition apparatus 400 decrypts Enc(P(D), Sig(H(P(D)), SKs0), Ku3) using the common key Ku3 and acquires P(D) and Sig(H(P(D)), SKs0). Then, the execution result acquisition apparatus 400 acquires the execution result P(D) after verifying the signature Sig(H(P(D)), SKs0) using the public key PKs0 and the hash function H. As a result, the execution result acquirer can obtain the execution result P(D).

As described above, according to the present embodiment, the user can detect that the public key PKs0 of the data sandbox (VMs0) has been tampered with by verifying AttestationReport #00. Furthermore, the user can detect that the policy π of the data sandbox (VMs0) has been tampered with by verifying one or both of AttestationReport #0 and AttestationReport #0′. In addition, the user can verify that the data sandbox (VMs0) is in a correct state by verifying AttestationReport #1 to #3 and can verify that the plaintext program P and data D that can be decrypted only in the data sandbox are the correct program P and data D (that is, the same as the hash value of the program P and the data D in the plaintext included in the agreed policy π). Thus, according to the present embodiment, for example, it is possible to prevent fraudulent acts such as falsification by the PF business operator.

### Supplement to Examples

The program P may be, for example, an artificial intelligence (AI) program, or the like, including a deep neural network (DNN), or the like. In this case, by performing code sign on the AI using the secret key of each user, it is also possible to clearly indicate which user's authority the AI has.
The AI may be read as digital twin.

### Hardware Configuration Example

All of the data processing apparatus 100, the program providing apparatus 200, the data holding apparatus 300 and the execution result acquisition apparatus 400 can be implemented, for example, by causing a computer to execute a program. This computer may be a physical computer or may be virtual machine. The data processing apparatus 100, the program providing apparatus 200, the data holding apparatus 300 and the execution result acquisition apparatus 400 are collectively referred to as an “apparatus”.

In other words, the apparatus can be implemented by executing a program corresponding to processing to be performed in the apparatus using a hardware resource such as a CPU and a memory built in the computer. The above program can be stored and distributed by being recorded in a computer-readable recording medium (portable memory, or the like). The program can also be provided through a network such as the Internet or an electronic mail.

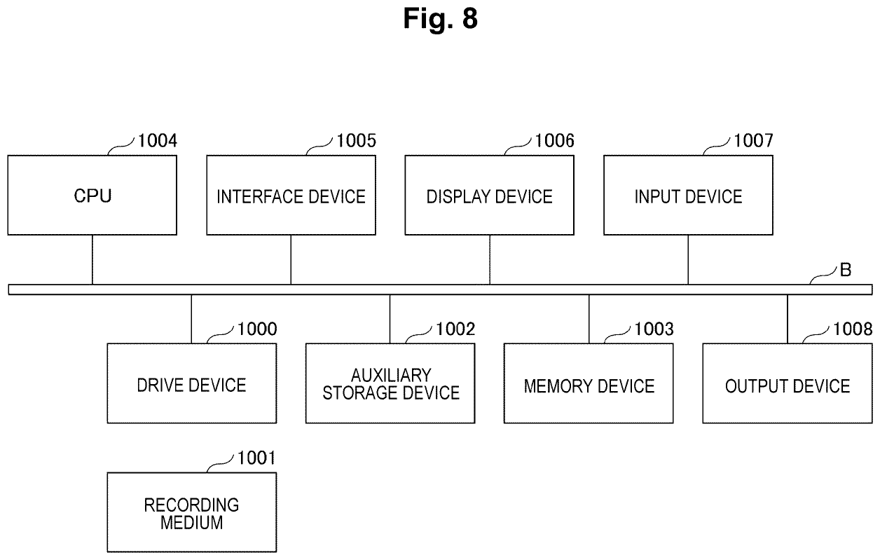

FIG. 8 is a view illustrating a hardware configuration example of the above computer. The computer in FIG. 8 includes a drive device 1000, an auxiliary storage device 1002, a memory device 1003, a CPU 1004, an interface device 1005, a display device 1006, an input device 1007, an output device 1008, and the like, which are connected to each other by a bus B. Note that some of these devices do not have to be included. For example, in a case where display is not to be performed, the display device 1006 does not have to be included.

The program for implementing processing in the computer is provided through a recording medium 1001 such as a CD-ROM or a memory card, for example. If the recording medium 1001 storing the program is set in the drive device 1000, the program is installed from the recording medium 1001 into the auxiliary storage device 1002 via the drive device 1000. Here, the program is not necessarily installed from the recording medium 1001 and may be downloaded from another computer via a network. The auxiliary storage device 1002 stores the installed program and also stores necessary files, data, and the like.

In a case where an instruction to activate the program is given, the memory device 1003 reads the program from the auxiliary storage device 1002 and stores the program. The CPU 1004 implements a function related to the apparatus in accordance with the program stored in the memory device 1003. The interface device 1005 is used as an interface for connection to a network and functions as a transmission unit and a reception unit. The display device 1006 displays a graphical user interface (GUI), or the like, according to the program. The input device 1007 includes a keyboard and a mouse, a button, a touchscreen, and the like, and is used to input various operation instructions. The output device 1008 outputs a calculation result.

### Effects of Embodiment

As described above, according to the technology according to the present embodiment, in a case where the data D of the data holder is processed by the program P of the program provider by the data processing apparatus 100 including the confidential calculation mechanism, it is possible to prevent the program P from being leaked to a person other than the program provider, prevent the data D from being leaked to a person other than the data holder, and detect falsification, or the like, of the public key or the policy π by a person (PF business operator) who manages the data processing apparatus 100. Furthermore, in addition to these, according to the technology according to the present embodiment, the user can verify that the data sandbox in which the program P is executed is in a correct state and can verify that the program P and the data D are correct.

### Summary of Embodiment

The present specification discloses at least the program execution system, the program execution method, and the program described in each of the following items.

### (Item 1)

A program execution system including a data holding apparatus and a data processing apparatus including a mechanism that performs confidential calculation in an isolated region,
the data holding apparatus transmitting a ciphertext Enc(D, Kd2) obtained by encrypting data D with a common key Kd2 to the data processing apparatus,
the data processing apparatus transmitting a public key PKs0 corresponding to a secret key SKs0 held in the isolated region and H(PKs0) (where H is a hash function) to which a signature is added by a hardware secret key included in hardware that implements the isolated region to the data holding apparatus,
the data holding apparatus transmitting a ciphertext PubEnc(Kd2, PKs0) obtained by encrypting the common key Kd2 with the public key PKs0 to the data processing apparatus,
the data processing apparatus acquiring the common key Kd2 by decrypting the ciphertext PubEnc(Kd2, PKs0) with the secret key SKs0 and acquiring the data D by decrypting the ciphertext Enc(D, Kd2) with the common key Kd2 in the isolated region, and
the data processing apparatus calculating a result P(D) of processing the data D by a program P held in the isolated region, in the isolated region.

### (Item 2)

The program execution system according to item 1, further including an execution result acquisition apparatus, in which
the data processing apparatus also transmits the public key PKs0 and H(PKs0) to which the signature is added by the hardware secret key to the execution result acquisition apparatus,
the execution result acquisition apparatus transmits a ciphertext PubEnc(Ku3, PKs0) obtained by encrypting a common key Ku3 with the public key PKs0 to the data processing apparatus, and
the data processing apparatus acquires the common key Ku3 by decrypting the ciphertext PubEnc(Ku3, PKs0) with the secret key SKs0 in the isolated region and transmits a ciphertext Enc(P(D), Ku3) obtained by encrypting the result P(D) with the common key Ku3 to the execution result acquisition apparatus.

### (Item 3)

The program execution system according to item 2, in which
the data holding apparatus transmits a random number r2 to the data processing apparatus,
the data processing apparatus transmits the random number r2 to which a signature Sig(r2, SKs0) is added by the secret key SKs0 to the data processing apparatus and transmits a second hash value representing a hash value of a character string obtained by combining the random number r2 or the signature Sig(r2, SKs0) and a hash value of information representing a state of the isolated region, and a signature added to the second hash value by the hardware secret key to the data holding apparatus,
the data holding apparatus verifies the signature Sig(r2, SKs0) with the public key PKs0 and also verifies whether or not a hash value of a character string obtained by combining the random number r2 or the signature Sig(r2, SKs0) and a hash value of a character string obtained by combining information representing an initial state of the isolated region and a hash value of the program P matches the second hash value,
the execution result acquisition apparatus transmits a random number r3 to the data processing apparatus,
the data processing apparatus transmits the random number r3 to which a signature Sig(r3, SKs0) is added by the secret key SKs0 to the execution result acquisition apparatus and transmits a third hash value representing a hash value of a character string obtained by combining the random number r3 or the signature Sig(r3, SKs0) and the hash value of information representing the state of the isolated region, and a signature added to the third hash value by the hardware secret key to the execution result acquisition apparatus, and
the execution result acquisition apparatus verifies the signature Sig(r3, SKs0) with the public key PKs0 and also verifies whether or not a hash value of a character string obtained by combining the random number r3 or the signature Sig(r3, SKs0) and a hash value of a character string obtained by combining the information representing the initial state of the isolated region, the hash value of the program P, and a hash value of the data D matches the third hash value.

### (Item 4)

The program execution system according to any one of items 1 to 3, in which assuming that a policy of the isolated region is n, the policy π includes a hash value H(P) of the program P and a hash value H(D) of the data D,
the data processing apparatus transmits, to the data holding apparatus, at least one of H(H(PKs0), H(π)) to which the signature is added by the hardware secret key or H(π) to which a signature is added by the secret key SKs0,
the data holding apparatus verifies at least one of the H(H(PKs0), H(π)) or the H(π), and
after the data processing apparatus acquires the program P by decrypting the ciphertext Enc(P, Kp1) with the common key Kp1, the data processing apparatus verifies whether or not a hash value of the acquired program P matches the H(P), and after the data processing apparatus acquires the data D by decrypting the ciphertext Enc(D, Kd2) with the common key Kd2, the data processing apparatus verifies whether or not a hash value of the acquired data D matches the H(D).

### (Item 5)

The program execution system according to item 1, further including a program providing apparatus, in which
the program providing apparatus transmits a ciphertext Enc(P, Kp1) obtained by encrypting the program P with a common key Kp1 to the data processing apparatus,
the program providing apparatus transmits a ciphertext PubEnc(Kp1, PKs0) obtained by encrypting the common key Kp1 with the public key PKs0 to the data processing apparatus, and
the data processing apparatus acquires the common key Kp1 by decrypting the ciphertext PubEnc(Kp1, PKs0) with the secret key SKs0 and acquires the program P by decrypting the ciphertext Enc(P, Kp1) with the common key Kp1 in the isolated region.

### (Item 6)

A program execution method in a program execution system including a data holding apparatus and a data processing apparatus including a mechanism that performs confidential calculation in an isolated region, the program execution method including:
the data holding apparatus transmitting a ciphertext Enc(D, Kd2) obtained by encrypting data D with a common key Kd2 to the data processing apparatus,
the data processing apparatus transmitting a public key PKs0 corresponding to a secret key SKs0 held in the isolated region and H(PKs0) (where H is a hash function) to which a signature is added by a hardware secret key included in hardware that implements the isolated region to the data holding apparatus,
the data holding apparatus transmitting a ciphertext PubEnc(Kd2, PKs0) obtained by encrypting the common key Kd2 with the public key PKs0 to the data processing apparatus,
the data processing apparatus acquiring the common key Kd2 by decrypting the ciphertext PubEnc(Kd2, PKs0) with the secret key SKs0 and acquiring the data D by decrypting the ciphertext Enc(D, Kd2) with the common key Kd2 in the isolated region, and
the data processing apparatus calculating a result P(D) of processing the data D by a program P held in the isolated region, in the isolated region.

### (Item 7)

A program for causing a computer to function as the data holding apparatus or the data processing apparatus included in the program execution system according to item 1.

Although the present embodiment has been described above, the present invention is not limited to specific embodiments, and various modifications and changes can be made within the scope of accompanying claims.

### REFERENCE SIGNS LIST

100 Data processing apparatus
110 Secure region
111 Secure data storage unit
112 Secure processing unit
120 Communication unit
130 Data storage unit
140 Data processing unit
200 Program providing apparatus
300 Data holding apparatus
400 Execution result acquisition apparatus
500 Secure channel
1000 Drive device
1001 Recording medium
1002 Auxiliary storage device
1003 Memory device
1004 CPU
1005 Interface device
1006 Display device
1007 Input device
1008 Output device
B Bus

1. A program execution system comprising:
a data holding apparatus including first circuitry configured to transmit a first ciphertext obtained by encrypting data with a common key, to a data processing apparatus; and
the data processing apparatus that includes second circuitry configured to transmit, to the data holding apparatus, both:
a public key corresponding to a secret key that is held in an isolated region, and
a hash value that is obtained by applying a hash function to the public key and to which a signature is added by a hardware secret key included in hardware that implements the isolated region, wherein
the first circuitry of the data holding apparatus is configured to transmit a second ciphertext obtained by encrypting the common key with the public key, to the data processing apparatus,
the second circuitry of the data processing apparatus is configured to:
acquire the common key that is obtained by decrypting the second ciphertext with the secret key, and
acquire the data by decrypting the first ciphertext with the common key in the isolated region, and
in the isolated region, the second circuitry of the data processing apparatus is configured to calculate a result of processing the data by a program that is held in the isolated region.

2. The program execution system according to claim 1, further comprising an execution result acquisition apparatus including third circuitry, wherein
the second circuitry of the data processing apparatus is configured to transmit, to the execution result acquisition apparatus, both:
the public key, and
the hash value obtained by applying the hash function to the public key and to which the signature is added by the hardware secret key,
the third circuitry of the execution result acquisition apparatus is configured to transmit a third ciphertext obtained by encrypting a second common key with the public key, to the data processing apparatus, and
the second circuitry of the data processing apparatus is configured to:
acquire the second common key by decrypting the third ciphertext with the secret key in the isolated region, and
transmit a fourth ciphertext obtained by encrypting the result with the second common key, to the execution result acquisition apparatus.

3. The program execution system according to claim 2, wherein the first circuitry of the data holding apparatus is configured to transmit a random number to the data processing apparatus,
the second circuitry of the data processing apparatus is configured to:
transmit, to the data holding apparatus, the random number to which a second signature is added by the secret key, and
transmit, to the data holding apparatus, both:
a second hash value representing a hash value of a character string obtained by combining either the random number or the second signature and a hash value of information representing a state of the isolated region, and
a third signature for the second hash value by the hardware secret key,
the first circuitry of the data holding apparatus is configured to:
verify the second signature with the public key, and
verify whether the hash value of the character string, obtained by combining either the random number or the second signature and a hash value of a character string that is obtained by combining information representing an initial state of the isolated region and a hash value of the program, matches the second hash value,
the third circuitry of the execution result acquisition apparatus is configured to transmit a second random number to the data processing apparatus,
the second circuitry of the data processing apparatus is configured to:
transmit the second random number to which a third signature is added by the secret key, to the execution result acquisition apparatus, and
transmit, to the execution result acquisition apparatus, both:
a third hash value representing a hash value of a character string obtained by combining either the second random number or the third signature and the hash value of the information representing the state of the isolated region, and
a fourth signature added to the third hash value by the hardware secret key, and
the third circuitry of the execution result acquisition apparatus is configured to:
verify the third signature with the public key, and
verify whether the hash value of the character string, obtained by combining either the second random number or the third signature and the hash value of the character string that is obtained by combining the information representing the initial state of the isolated region, the hash value of the program, and a hash value of the data, matches the third hash value.

4. The program execution system according to claim 1, wherein
when a policy of the isolated region includes
a hash value that is obtained by applying the hash function to the program, and
a hash value that is obtained by applying the hash function to the data,
the second circuitry of the data processing apparatus is configured to transmit, to the data holding apparatus, at least one of:
a hash value of a character string obtained by combing a hash value of the public key and a hash value of the policy through the hash function, wherein the signature is added to the hash value of the character string by the hardware secret key, or
a hash value that is obtained by applying the hash function to the policy, and to which a signature is added by the secret key,
the first circuitry of the data holding apparatus is configured to verify at least one of the hash value of the character string, or the hash value obtained by applying the hash function to the policy, and
the second circuitry of the data processing apparatus is configured to:
acquire the program by decrypting a third ciphertext with a second common key,
after acquiring the program, verify whether a hash value of the acquired program matches the hash value obtained by applying the hash function to the program, and
acquire the data by decrypting the second ciphertext with the common key, and
after acquiring the data, verify whether a hash value of the acquired data matches the hash value obtained by applying the hash function to the data.

5. The program execution system according to claim 1, further comprising a program providing apparatus including third circuitry configured to:
transmit a third ciphertext obtained by encrypting the program with a second common key, to the data processing apparatus, and
transmit a fourth ciphertext obtained by encrypting the second common key with the public key, to the data processing apparatus, wherein
the second circuitry of the data processing apparatus is configured to:
acquire the second common key that is obtained by decrypting the fourth ciphertext with the secret key, and
acquire the program by decrypting the third ciphertext with the second common key in the isolated region.

6. A program execution method executed by a program execution system including a data holding apparatus and a data processing apparatus, comprising:
transmitting, by the data holding apparatus, a first ciphertext obtained by encrypting data with a common key, to the data processing apparatus;
transmitting, by the data processing apparatus, to the data holding apparatus, both:
a public key corresponding to a secret key that is held in an isolated region, and
a hash value that is obtained by applying a hash function to the public key and to which a signature is added by a hardware secret key included in hardware that implements the isolated region;
transmitting, by the data holding apparatus, to the data processing apparatus, a second ciphertext obtained by encrypting the common key with the public key;
acquiring, by the data processing apparatus, the common key that is obtained by decrypting the second ciphertext with the secret key;
acquiring, by the data processing apparatus, the data by decrypting the first ciphertext with the common key in the isolated region; and
calculating, by the data processing apparatus, a result of processing the data by a program that is held in the isolated region.

7. A non-transitory computer readable storage medium storing a program configured to cause a computer to execute the program execution method of claim 6.
